(19) United States
(12) Patent Application Publication
(10) Pub. No.: US 2017/0028464 A1
(43) Pub. Date: Feb. 2, 2017

(54) METHOD FOR PRODUCING A PISTON FOR A COMBUSTION ENGINE

(71) Applicant: Mahle International GmbH, Stuttgart (DE)

(72) Inventors: Martin Ruehle, Stuttgart (DE); Udo Rotmann, Marburg (DE)

(73) Assignees: Mahle International GmbH, Stuttgart (DE); Mahle International GmbH, Stuttgart (DE)

(21) Appl. No.: 15/106,302

(22) PCT Filed: Dec. 11, 2014
(86) PCT No.: PCT/EP2014/077431

§ 371 Date: Jun. 19, 2016

(30) Foreign Application Priority Data
Dec. 19, 2013 (DE) 10 2013 226 717.7

(51) Int. Cl. B22D 19/00; B22D 21/00; B22C 9/24; B22D 18/06; F02F 3/00; F16J 1/01

(52) U.S. Cl. CPC B22D 19/0027; F02F 3/0084; F16J 1/01; B22C 9/24; B22D 18/06; B22D 21/007

(57) ABSTRACT

A method for producing a piston with a combustion bowl may include fastening an annular fibrous preform for reinforcing a periphery of the combustion bowl in a casting mold for the piston coaxially with a piston axis in a plane of a piston head. The method may also include introducing a metal melt into the casting mold to produce a piston blank, generating a pressure difference between the metal melt and the fibrous preform for infiltration of the metal melt into the fibrous preform, and machining the piston blank. The fibrous preform may be held in the casting mold by suction tubes in which a negative pressure may prevail such that the metal melt may be sucked into and infiltrate the fibrous preform. At least one section of at least one of the suction tubes may accelerate solidification of the metal melt passing into the suction tube.

### CROSS-REFERENCE TO RELATED APPLICATIONS

This application claims priority to German Patent Application 10 2013 226 717.7 filed on Dec. 19, 2013 and PCT/EP2014/077431 filed on Dec. 11, 2014, which are hereby incorporated by reference in their entireties.

### TECHNICAL FIELD

The invention relates to a method for producing a piston.

### BACKGROUND

Fluid energy machines in which pistons execute, in cylinders, a periodic translatory movement transmitted via pushrods are known as piston engines in mechanical engineering. The probably most widespread type of piston engine is in this case the reciprocating piston engine, which converts the change in volume of a gas into the described linear movement of the piston and converts it further into a rotary movement via a connecting rod and a crank. In the probably most common variant of the piston engine, the combustion engine, the piston comprises a combustion bowl for this purpose.

Suitable pistons are regularly produced by means of a primary forming method, in particular with the aid of specialist casting techniques, according to the prior art. The permanent mold casting method known from metal processing, in which a melt is poured via a top ingate into a metal permanent mold and fills the cavity therein substantially only as a result of gravitational force, has proven particularly successful.

The compensation of the extremely high thermal load, occurring during operation of the engine, in the peripheral region of the combustion bowl, which can result in the formation of cracks in the piston under unfavorable circumstances, proves to be a problem here. The use of cooled ring carriers for example is known from the prior art with regard to this problem. The bowl periphery is increasingly also reinforced by the incorporation of ceramic fibers by casting. For this purpose, pressurization after mold filling is sometimes used as the permanent mold casting method, in order to ensure the complete infiltration of the ceramic fibers through the aluminum melt and thus to favor the incorporation of the ceramic fibers into the metal microstructure.

A corresponding method is known from the embodiment in claim 4 of DE 10 2004 056 519 A1. According to that approach, first of all an annular fibrous preform is fastened in the casting mold in order to reinforce the periphery of the combustion bowl. Subsequently, a liquid aluminum or aluminum alloy melt is introduced into the casting mold, the fibrous preform being infiltrated thereby and being molded into the bowl periphery as part of the casting operation. The piston blank produced in this way is subsequently subjected to a thermal treatment before the piston is finished by means of a chip-removing manufacturing method. The pressure difference between the aluminum alloy melt and the fibrous preform is in this case caused by the fibrous preform being held in the casting mold by suction tubes (in addition to other fasteners that may be present), wherein a negative pressure prevails in the suction tubes such that the aluminum alloy melt is sucked into the fibrous preform thereby and infiltrates the fibrous preform. Apart from the possibility of using the suction tubes to hold the fibrous preform by way of the negative pressure, the attached vacuum pump helps, by reducing the residual gas pressure to preferably less than 0.1 bar, to more completely vent the cavities in the fibrous preform prior to the penetration of the melt and as a result to preventing the formation of air inclusions. In addition, the melt is put under a pressure of typically up to 20 bar by the application of a positive pressure to the melt in the permanent mold. As a result, a very high-quality and in particular highly loadable piston is intended to be produced, which is subsequently free of included air in the infiltrated fibrous preform.

In this connection, the solidification behavior of the aluminum melt infiltrating the fibrous preform proves to be critical. Premature solidification of the melt within the fibrous preform prior to the conclusion of the infiltration leaves undesired cavities free. If, by contrast, the melt flows through the suction tube after infiltration, it can enter the vacuum pump and plug or constrict ducts therein. In this respect, both early and late hardening of the melt can considerably impair the quality of the method result.

### SUMMARY

Therefore, the invention is based on the object of improving a generic production method such that it allows defined solidification of the melt used, without air inclusions arising in the fibrous preform.

This object is achieved by a method having the features of the independent claims. Advantageous embodiments are the subject matter of the dependent claims.

The invention is accordingly based on the basic idea of providing the suction tubes that are also used to hold the fibrous preform in the casting mold with a specifically designed section which favors selective solidification of the melt in the desired section of the suction tubes and as a result plugs the suction tube for the following melt. According to the invention the flow of the melt is brought to a standstill only after complete infiltration of the fibrous preform by solidification deliberately caused while still within the suction tube. Such a “target solidification section” can be realized in this case by means of a thermal approach, on the one hand, and by means of a geometric approach, on the other hand. In this case, the specifically designed section of the suction tube is configured such that it favors selectively early solidification of the melt in particular without further components or inserts, that is to say intrinsically.

The solidification of the melt can be brought about in a thermal manner for instance by local cooling of the suction tube. Alternatively, the selection of a suitable material can accelerate the solidification of the melt, as long as the corresponding material has increased thermal conductivity compared with the melt. The use of copper as the material of the tube comes into consideration, for example, in combination with a subeutectic aluminum-silicon melt.

A geometric solution to the problem can also take place in different ways. First of all, the formation of a narrow point in the course of the suction tube, which locally reduces the flow cross section thereof, is conceivable. A similar effect can be achieved by means of a bent or kinked tube section, by means of combinations of cross-sectional narrowings and/or changes in direction, or generally by means of any labyrinthine obstacle along the course of the suction tube.

Further important features and advantages of the invention can be gathered from the dependent claims, the drawings and the associated description of the figures with reference to the drawings.

It goes without saying that the features mentioned above and those yet to be explained below are usable not only in the combination specified in each case but also in other combinations or on their own without departing from the scope of the present invention.

Preferred exemplary embodiments of the invention are illustrated in the drawings and are explained in more detail in the following description, wherein identical reference signs refer to identical or similar or functionally identical components.

### BRIEF DESCRIPTION OF THE DRAWINGS

In the drawings, in each case schematically

FIG. 1 shows a plan view of the head of a piston produced by the method according to the invention, and

FIG. 2 shows a section through the casting mold along the axis of the piston with two different embodiments of the suction tubes according to the invention, which are illustrated on the right-hand and left-hand sides of the figure.

### DETAILED DESCRIPTION

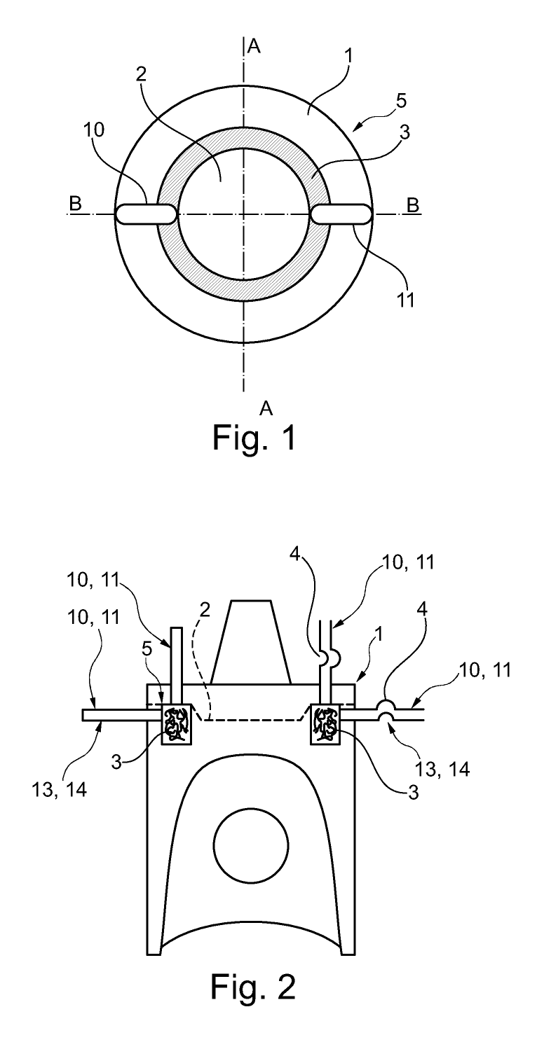

FIGS. 1 and 2 illustrate the implementation of the production method according to one embodiment of the invention, wherein a specific light metal melt is used here as the basic material of the piston 1 to be manufactured. It is in this case preferably a subeutectic aluminum-silicon alloy (AlSi alloy) the microstructure of which was influenced by finishing with respect to the mechanical loads to be expected during operation of the piston 1.

The periphery of the combustion bowl 2 on the piston head 5 is in this case reinforced by means of a fibrous preform 3. A sufficiently large pressure difference between the light metal melt and fibrous preform 3 in this case ensures that the fibrous preform 3 is infiltrated entirely with the light metal melt used during casting, before the latter solidifies.

The fibers of the fibrous preform 3 are configured as short fibers of a ceramic material, for example of alumina (Al₂O₃), also known as electrocorundum primarily in the technical field and based on the clay or silica fibrous products marketed under the trade name Saffil. Alternative embodiments may have a fiber orientation that deviates from the random-planar standard, without departing from the scope of the invention. The fibrous preform 3 in the form of an annular body with a rectangular cross section is produced in that the fibers are initially processed to form an aqueous suspension containing a binder. Subsequently, the suspension is filled into a water permeable mold, corresponding to the shape of the fibrous preform 3, in which the water is separated from the suspension. The resulting body in the form of the fibrous preform 3 is dried and can be subjected to mechanical follow-up pressing in order to improve its strength. What is desired here is a proportion of 10% to 20% fibers per volume unit. Before being introduced into the casting mold, the fibrous preform 3 is preheated, in order to exclude moisture inclusions.

In order to produce the piston 1, together with its combustion bowl 2 embodied in the form of a round blind hole, in as leaktight and pore-free a manner as possible, use is made in the present case of a permanent mold casting method, in which the light metal melt passes under gravity via a casting ladle into the casting mold serving as permanent mold. In the present embodiment, after completion of mold filling, a pressure of between 0.5 bar and 20 bar is used, wherein a locking frame (not illustrated in FIGS. 1 and 2) of the casting mold, said locking frame being sealed off by means of obliquely tightened locking pins, serves for reliably absorbing the pressure forces.

In this case, first of all the parts incorporated by casting, such as the fibrous preform 3, are fastened in the casting mold at the locations provided therefor, preferably in combination with a salt core and/or a ring carrier or a cooled ring carrier.

Subsequently, the casting mold is closed by a cover which has two suction tubes 10, 11 arranged radially on the outside, which are connected to a vacuum pump (not shown) and lead into the interior of the casting mold at such locations that the fibrous preform 3 bears against the openings of the suction tubes 10, 11 and is held at the location provided therefor by the negative pressure prevailing in the tubes 10, 11. Via an inlet, the light metal melt is now introduced into the casting mold, wherein the negative pressure prevailing in the suction tubes 10, 11 has the effect that the fibrous preform 3 held against the suction tubes 10, 11 is infiltrated by the light metal melt. The suction tubes 10, 11 leading into the fibrous preform 3 are in this case resiliently preloaded against the fibrous preform 3 and are cooled to a temperature which considerably accelerates the solidification of the light metal melt. Also conceivable are suction tubes 10, 11 having high thermal conductivity, which favor rapid solidification of the melt by heat dissipation. Provided on each suction tube 10, 11 is at least one section 13, 14 which accelerates the solidification of the melt entering the suction tube 10, 11. The section can be configured in this case as a narrowing or bend.

From a geometrical point of view, too, the in particular copper suction tubes 10, 11 are optimized with the aim of accelerated solidification of the light metal melt. To this end, the suction tubes 10, 11 each have an individual wave train with a local offset 4 of the tube axis, which, on closer observation, consists of kinks or bends of the tube axis. In the region of the bend or of the offset 4, a local cross-sectional narrowing occurs in each case by the opposite tube walls coming closer together. Changes in direction of the tube axis by way of bends without a change in cross section can also be used according to the invention, however, as can pure constrictions or changes in cross section without a change in direction of the tube axis. In general, any desired labyrinthine geometries can be selected, which represent an obstacle for the flowing melt by narrowing and/or deflection, it being possible for the solidification to start preferably at said obstacle.

In the embodiment shown on the left-hand side of FIG. 2, the suction tubes 10, 11 consist of copper or some other material which has greater thermal conductivity than the melt. Alternatively or in addition, the suction tubes 10, 11 can be cooled before insertion into the casting mold. Generally, as a result of the thermal properties of the suction tubes 10, 11, the melt passing through the fibrous preform 3 after complete infiltration preferably solidifies in the suction tube 10, 11 and plugs the latter.

The geometrical and thermal realizations of the target solidification region according to the invention in the suction tube 10 or 11 are only expediently illustrated in the same drawing. The casting method according to the invention can also be carried out with only one variant. On the other hand, it is of course possible to combine geometrical and thermal solutions and to additionally provide for example a suction tube made of copper with a constriction in order to enhance the effect according to the invention.

In addition, the permanent casting mold is connected to a compressed air line, via which air under high pressure is introduced into the casting mold after the casting mold has been filled with the light metal melt, in order to considerably reduce the porosity of the solidified aluminum alloy and in this way to give the piston 1 sufficient strength. Subsequently, both the individual fibers of the fibrous preform 3 are connected firmly to the solidified light metal melt and the fibrous preform 3 is for its part connected to the remaining regions of the piston 1.

Next, the piston blank is given the final shape of the piston 1 by means of a chip-removing manufacturing method. In order to further improve the quality of the piston 1, the flanks and the bases of the annular grooves (not shown), which are subjected to particular loading especially when the piston is used in the context of a generic diesel engine, can be provided with a wear resistant coating by way of what is known as anodization.

1. A method for producing a piston with a combustion bowl, comprising the following method steps of:
fastening an annular fibrous preform for reinforcing a periphery of the combustion bowl in a casting mold for the piston coaxially with a piston axis in a plane of a piston head,
introducing a metal melt into the casting mold to produce a piston blank,
generating a pressure difference between the metal melt and the fibrous preform infiltration of the metal melt into the fibrous preform, where the fibrous preform is held in the casting mold by suction tubes in which a negative pressure prevails such that the metal melt is sucked into the fibrous preform and infiltrates the fibrous preform,
machining the piston blank,
wherein at least one section of at least one of the suction tubes accelerates solidification of the metal melt passing into the suction tube.

2. The method as claimed in claim 1, wherein the metal melt is a light-metal melt.

3. The method as claimed in claim 1, further comprising densifying a ceramic fiber, to form the fibrous preform such that the ceramic fiber takes up a volume fraction of 10% to 20% of the fibrous preform.

4. The method as claimed in claim 1,
further comprising applying, by a vacuum pump, the negative pressure with a gas pressure of below 0.1 bar to the suction tubes.

5. The method as claimed in claim 1, wherein the method includes permanent mold casting or low-pressure casting method.

6. The method as claimed in claim 1, wherein the casting mold has at least one partition which is subjected to a counterpressure such that the metal melt does not pass through the partition.

7. The method as claimed in claim 1, wherein at least one of the suction tubes leads into the fibrous preform and is preloaded against the fibrous preform.

8. The method as claimed in claim 1, wherein the at least one section has greater thermal conductivity than the metal melt.

9. The method as claimed in claim 1, further comprising cooling of at least one of the suction tubes (10, 11) before the melt is introduced into the casting mold.

10. The method as claimed in claim 1, wherein the at least one section has a constriction.

11. The method as claimed in claim 1, wherein the at least one section has at least one bend or kink.

12. The method as claimed in claim 1, wherein the pressure difference is brought about by the negative pressure in the suction tubes in combination with pressurization of the metal melt.

13. The method as claimed in claim 1, wherein the metal melt is a subeutectic aluminum-silicon melt.

14. The method as claimed in claim 2, further comprising densifying a ceramic fiber to form the fibrous preform such that fiber takes up a volume fraction of 10% to 20% of the fibrous preform.

15. The method as claimed in claim 14, wherein the ceramic fiber includes Al₂O₃.

16. The method as claimed in claim 5, wherein the permanent mold casting or low-pressure casting includes redensification between 0.5 and 20 bar.

17. The method as claimed in claim 1, characterized in that wherein the at least one section is made of copper.

18. A method for producing a piston with a combustion bowl, comprising:
densifying a ceramic fiber to form an annular fibrous preform, the fibrous preform taking up a volume fraction of 10% to 20% of the fibrous preform,
fastening the fibrous preform for reinforcing a periphery of the combustion bowl in a casting mold for the piston coaxially with a piston axis in a plane of a piston head,
introducing a metal melt into the casting mold to produce a piston blank,
applying, by a vacuum pump, a negative pressure with a gas pressure of below 0.1 bar to suction tubes holding the fibrous preform in the casting mold to generate a pressure difference between the metal melt and the fibrous preform such that the metal melt is sucked into the fibrous preform and infiltrates the fibrous preform,
machining the piston blank,
wherein at least one section of at least one of the suction tubes accelerates solidification of the metal melt passing into the suction tube.

19. The method as claimed in claim 18, wherein at least one of the suction tubes leads into the fibrous preform and is preloaded against the fibrous preform.

20. The method as claimed in claim 18, wherein the at least one section has greater thermal conductivity than the metal melt.
